(19) United States
(12) Patent Application Publication
(10) Pub. No.: US 2025/0208307 A1
(43) Pub. Date: Jun. 26, 2025

(54) RADIATION DETECTOR, RADIATION IMAGING SYSTEM, RADIATION DETECTION METHOD, AND STORAGE MEDIUM

(71) Applicant: CANON KABUSHIKI KAISHA, Tokyo (JP)

(72) Inventors: MASATO AIHARA, Kanagawa (JP); TATSUHITO GODEN, Tokyo (JP); TAKANORI WATANABE, Kanagawa (JP)

(21) Appl. No.: 18/966,577

(22) Filed: Dec. 3, 2024

(30) Foreign Application Priority Data
Dec. 20, 2023 (JP) 2023-215170

(51) Int. Cl. G01T 1/24

(52) U.S. Cl. CPC G01T 1/247

(57) ABSTRACT

A radiation detector includes a plurality of pixels, an A/D converter configured to execute first A/D conversion processing of comparing the voltage signal with a first reference signal and converting the voltage signal into a digital signal of three or more values and second A/D conversion processing of comparing the voltage signal with a second reference signal and converting the voltage signal into a digital signal of three or more values, and a signal processing unit. The first reference signal is a signal that changes over time in a first voltage region including a mode of the voltage signal output from a pixel that has not received the radiation. The second reference signal is a signal that changes over time in a second voltage region that includes the voltage signal output from a pixel that has received the radiation and does not overlap the first voltage region.

### BACKGROUND

### Technical Field

The present disclosure relates to a radiation detector and the like.

### Description of the Related Art

A radiation detector that obtains a radiation image by receiving radiation with a semiconductor element such as a complementary metal-oxide-semiconductor (CMOS) image sensor without using a scintillator (wavelength converter) has been known. In such a radiation detector, it is required to remove a background component generated by a dark current or the like flowing through a sensor unit from a detected image signal in order to acquire a good image.

JP-T-2008-524874 describes that in an X-ray imaging system that detects an X-ray with a CMOS image sensor, a signal of a pixel in a certain image frame is corrected based on a signal of the pixel in a different image frame.

JP 2023-160729 A proposes a method of obtaining a background component at a timing when an imaging target is imaged. This is a method of obtaining a background component included in a plurality of pixels in a certain frame by using a value of a pixel signal read in the frame.

In the method described in JP-T-2008-524874, a level of a dark current of the image sensor is measured in advance at a time different from a time at which an imaging target is imaged in a state where no radiation is applied, and a correction coefficient is calculated. Then, when the imaging target is imaged, an image signal obtained by imaging the imaging target is calibrated using the correction coefficient based on the dark current measured at the different time.

However, the dark current of the image sensor is not always constant, and when a temperature changes, for example, due to the application of the radiation, the dark current may change accordingly. For this reason, in a case where the image signal obtained by imaging the imaging target is calibrated using the correction coefficient acquired in advance in a state where no radiation is applied as in JP-T-2008-524874, the calibration does not necessarily correctly reflect the dark current at the time at which the imaging is performed. For example, in a case where imaging is continuously performed while radiation is applied, the temperature of the sensor rises with the lapse of time, and the dark current changes, as a result of which image quality may be unstable or may deteriorate.

In this regard, the method described in JP 2023-160729 A has a possibility of obtaining stable image quality even in a case where the background component such as the dark current changes over time.

On the other hand, in the field of acquiring a binarized image using a radiation detector and performing so-called counting, it is required to acquire an appropriate binarized image at a high frame rate.

Therefore, there has been a demand for a technology capable of quickly acquiring a background component at a time point at which a target object is imaged by applying radiation even in a case where the background component such as the dark current changes over time.

### SUMMARY

According to a first aspect of the present disclosure, a radiation detector includes a plurality of pixels, an A/D converter configured to execute first A/D conversion processing of comparing the voltage signal with a first reference signal and converting the voltage signal into a digital signal of three or more values and second A/D conversion processing of comparing the voltage signal with a second reference signal and converting the voltage signal into a digital signal of three or more values, and a signal processing unit. Each pixel is configured to detect radiation and output voltage signal. The first reference signal is a signal that changes over time in a first voltage region including a mode of the voltage signal output from a pixel that has not received the radiation. The second reference signal is a signal that changes over time in a second voltage region that includes the voltage signal output from a pixel that has received the radiation and does not overlap the first voltage region. A third voltage region where A/D conversion processing is not executed is present between the first voltage region and the second voltage region.

According to a second aspect of the present disclosure, a radiation detection method includes a reading step of reading, by a read circuit, voltage signals from a plurality of pixels, each pixel being configured to detect radiation and output voltage signal, a first A/D conversion step of comparing, by an A/D converter, the voltage signal with a first reference signal and converting the voltage signal into a digital signal of three or more values, and a second A/D conversion step of comparing, by the A/D converter, the voltage signal with a second reference signal and converting the voltage signal into a digital signal of three or more values. The first reference signal is a signal that changes over time in a first voltage region including a mode of the voltage signal output from a pixel that has not received the radiation. The second reference signal is a signal that changes over time in a second voltage region that includes the voltage signal output from a pixel that has received the radiation and does not overlap the first voltage region. A third voltage region where the A/D converter does not execute A/D conversion processing is present between the first voltage region and the second voltage region.

Further features of the present invention will become apparent from the following description of exemplary embodiments with reference to the attached drawings.

### BRIEF DESCRIPTION OF THE DRAWINGS

FIG. 1A is a block diagram illustrating a schematic configuration of a radiation detector 100 according to a first embodiment.

FIG. 1B is a schematic circuit diagram illustrating a configuration example of one pixel.

FIG. 2 is a diagram illustrating a configuration example of an A/D converter included in a column circuit in the first embodiment.

FIG. 3 is a graph illustrating a temporal change of a reference signal (ramp voltage) output from a reference signal generation circuit in the first embodiment.

FIG. 4A is a schematic diagram illustrating a situation in which radiation is applied to the radiation detector.

FIG. 4B is a histogram illustrating an example of a relationship between a level of a pixel signal output from each pixel and the number of pixels when imaging of one frame is performed.

FIG. 5 is a schematic block diagram illustrating an example of a configuration of a radiation imaging system according to the first embodiment.

FIG. 6 is a flowchart illustrating a procedure of setting processing executed before executing a high-speed A/D conversion mode.

FIG. 7 illustrates an example in which the number of pixels for each signal level is represented as a histogram.

FIG. 8 is a flowchart illustrating a procedure for imaging a target object in the high-speed A/D conversion mode and acquiring a binarized image.

FIG. 9 is a graph illustrating a temporal change of a reference signal (ramp voltage) output from a reference signal generation circuit in a second embodiment.

FIG. 10 is a diagram illustrating a configuration example of an A/D converter included in a column circuit in the second embodiment.

FIG. 11 is a flowchart illustrating a procedure of processing executed by a radiation detector according to a third embodiment.

FIG. 12A is a diagram illustrating a filter region of an arithmetic filter in a fourth embodiment.

FIG. 12B is a diagram illustrating an example in which a value of a pixel signal in a region to which the arithmetic filter is applied is represented as a histogram.

FIG. 12C is a diagram for describing two-dimensional sweeping of the arithmetic filter.

FIG. 13A is a schematic diagram illustrating equipment serving as a radiation imaging system according to a fifth embodiment.

FIG. 13B is a schematic diagram illustrating a configuration of a transmission electron microscope serving as the radiation imaging system according to the fifth embodiment.

### DESCRIPTION OF THE EMBODIMENTS

A radiation detector and the like according to an embodiment of the present disclosure will be described with reference to the drawings. The embodiments described below are merely examples, and for example, detailed configurations can be appropriately changed and implemented by those skilled in the art without departing from the gist of the present disclosure.

In the drawings referred to in the following description of the embodiments and examples, elements denoted by the same reference signs have the same functions unless otherwise specified. In the drawings, in a case where a plurality of the same elements is arranged, reference signs and a description thereof may be omitted.

In addition, the drawings may be schematic for convenience of illustration and description, and thus, the shape, size, arrangement, and the like of elements in the drawings may not strictly match those of actual ones. In addition, “XX or more and YY or less” or “XX to YY” representing a numerical range means a numerical range including end points XX (lower limit) and YY (upper limit) unless otherwise specified. When numerical ranges are described in stages, the upper limit and the lower limit of each numerical range can be arbitrarily combined.

In the following description, “radiation” is a concept including electromagnetic radiation (X-ray, gamma ray, or the like), particle radiation (electron beam, proton beam, neutron beam, alpha beam, or the like), and non-ionizing radiation (radio waves, microwaves, infrared rays, visible rays, or the like). A “radiation imaging system” refers to a general system that acquires an image of a target object as electronic data by using radiation. The imaging target is, for example, an inspection target object in the case of a non-destructive inspection system, and is a patient in the case of a medical imaging system. An “image” is a still image or a moving image. A “radiation detector” is a constituent element of the radiation imaging system and refers to an image sensor unit that converts a radiation image into an electrical signal and acquires an image serving as electronic data.

In the following description, an analog signal output from each pixel of the radiation detector may be referred to as a pixel signal. Furthermore, a signal obtained by quantizing the pixel signal into two values may be referred to as a binary pixel signal. Furthermore, a signal obtained by quantizing the pixel signal into three or more values may be referred to as a multi-value pixel signal. In addition, an image for one frame formed from the binary pixel signal may be referred to as a binarized image.

In each embodiment described below, when capturing an image of one frame, A/D conversion is performed on a first voltage region including a signal level of a mode of a background component for a pixel signal of the one frame to acquire a first digital signal (multi-value digital signal). Further, A/D conversion is performed on a second voltage region including a signal level of a pixel receiving the radiation for the pixel signal of the one frame to acquire a second digital signal (multi-value digital signal). In each embodiment, an A/D converter capable of quickly acquiring the first digital signal and the second digital signal is implemented.

Known technologies such as US 2016/0309105 A1 which is a U.S. Patent Publication and WO 2019/064632 A1 which is International Patent Publication can be referred to for a specific method of setting a binarization determination threshold and counting in the embodiments.

### First Embodiment

### Configuration of Radiation Detector

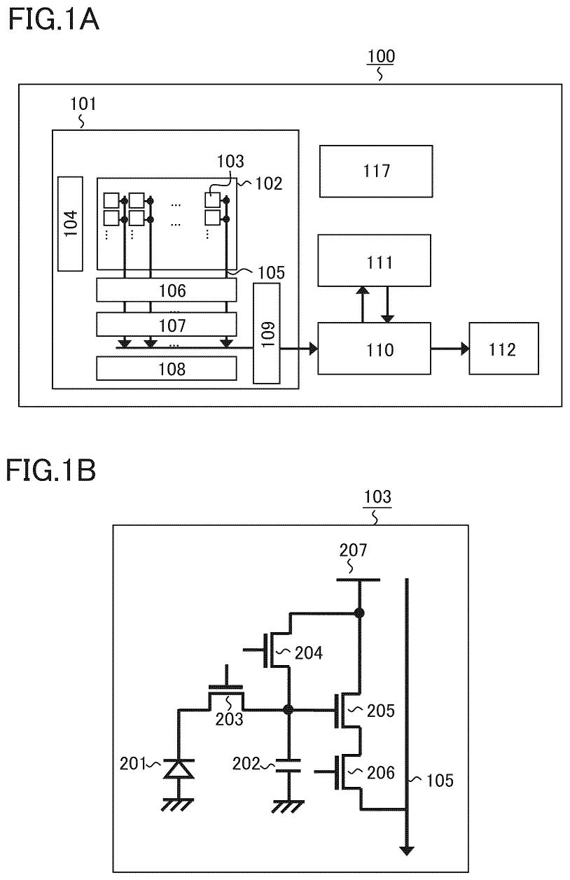

FIG. 1A is a block diagram illustrating a schematic configuration of a radiation detector 100 according to a first embodiment. The radiation detector 100 includes an imaging element 101, an output signal processing unit 110, a memory unit 111, an external interface unit 112, and a control unit 117. Each illustrated functional element is functionally conceptual, and does not necessarily have to be physically configured as illustrated. For example, a specific form of distribution or integration of the functional blocks is not limited to the illustrated example, and all or some of the functional blocks can be functionally or physically distributed and integrated in arbitrary units according to a use situation or the like.

The imaging element 101 includes a pixel array 102 including a plurality of pixels 103 arranged in a matrix, a vertical scanning circuit 104, a vertical signal line 105, a column circuit 106, a column memory 107, a horizontal scanning circuit 108, and a DFE 109. Here, the DFE is an abbreviation of digital front end. The vertical scanning circuit 104, the vertical signal line 105, the column circuit 106, the column memory 107, and the horizontal scanning circuit 108 are examples of read circuits that read a pixel signal from each pixel of the pixel array 102 for each frame. The DFE 109 is an example of a processing circuit (signal processing unit) that processes the pixel signal read by the read circuit. The imaging element 101 is a complementary metal-oxide-semiconductor (CMOS) image sensor that detects radiation.

The pixels 103 included in the pixel array 102 convert injected radiation into electric charges. A configuration of the pixel 103 is described below. The vertical scanning circuit 104 selects a pixel row from which a signal is output in the pixel array 102, and performs scanning while sequentially switching a row to be selected. The vertical signal line 105 transmits a signal from the pixel 103 of the row selected by the vertical scanning circuit 104. The column circuit 106 processes the signal input from the vertical signal line 105. The processing executed by the column circuit 106 includes A/D conversion. The column memory 107 holds a digital signal (multi-value pixel signal) output from the column circuit 106. The horizontal scanning circuit 108 scans the column circuit 106 or the column memory 107 in a direction of the pixel column to sequentially read the digital signal (multi-value pixel signal) for each column. The DFE 109 is an output circuit that processes the digital signal read from the column circuit 106 or the column memory 107 and outputs the processed signal to the outside of the imaging element 101.

The output signal processing unit 110 performs arithmetic processing on the signal output from the imaging element 101. The memory unit 111 is a data holding unit (storage area) for performing an arithmetic operation in the output signal processing unit 110, and holds processing target data and predetermined data. A signal output from the output signal processing unit 110 is output to the outside of the radiation detector 100 through the external interface unit 112.

The control unit 117 controls an operation of each unit of the radiation detector 100, and transmits and receives a signal related to operation control to and from the outside of the radiation detector 100 when configuring a radiation imaging system described below.

FIG. 1B is a schematic circuit diagram illustrating a configuration example of one pixel 103 in FIG. 1A. The pixel 103 includes a photodiode 201, a floating diffusion capacitor 202, a transistor 203, a transistor 204, a transistor 205, and a transistor 206.

The photodiode 201 is a conversion element that converts injected radiation into electric charges. An anode of the photodiode 201 is connected to a reference voltage node, and a cathode of the photodiode 201 is connected to a source of the transistor 203. A drain of the transistor 203 is connected to a source of the transistor 204 and a gate of the transistor 205. A connection node of the drain of the transistor 203, the source of the transistor 204, and the gate of the transistor 205 make up a so-called floating diffusion unit. The floating diffusion unit includes a capacitance component (floating diffusion capacitor 202) and functions as a charge holding unit.

A drain of the transistor 204 and a drain of the transistor 205 are connected to a power supply voltage node 207 to which a power supply voltage is supplied. A source of the transistor 205 is connected to a drain of the transistor 206. A source of the transistor 206 is connected to the vertical signal line 105. The vertical signal line 105 is connected to a current source.

A signal line for transmitting a control signal from the vertical scanning circuit 104 is connected to each of gates of the transistor 203, the transistor 204, and the transistor 206. Each signal line is a signal line common to the row to which the pixel 103 belongs in the pixel array 102.

When the radiation is injected to the pixel 103, the photodiode 201 converts the radiation into charges (signal charges) and accumulates the charges. The transistor 203 (transfer transistor) transfers the signal charges accumulated in the photodiode 201 to the floating diffusion unit based on the control signal from the vertical scanning circuit 104. The floating diffusion unit holds the charges transferred from the photodiode 201, and holds a voltage corresponding to the amount of transferred charges by charge-voltage conversion by the floating diffusion capacitor 202.

The transistor 205 (amplification transistor) amplifies the pixel signal based on the charges held by the floating diffusion unit and outputs the amplified pixel signal to the transistor 206. The transistor 206 (selection transistor) outputs the pixel signal from the transistor 205 to the vertical signal line 105 based on the control signal from the vertical scanning circuit 104. The transistor 204 (reset transistor) resets the floating diffusion unit to a voltage corresponding to the power supply voltage based on the control signal from the vertical scanning circuit 104. The transistor 203 may be omitted, and the photodiode 201 and the floating diffusion capacitor 202 may be directly connected.

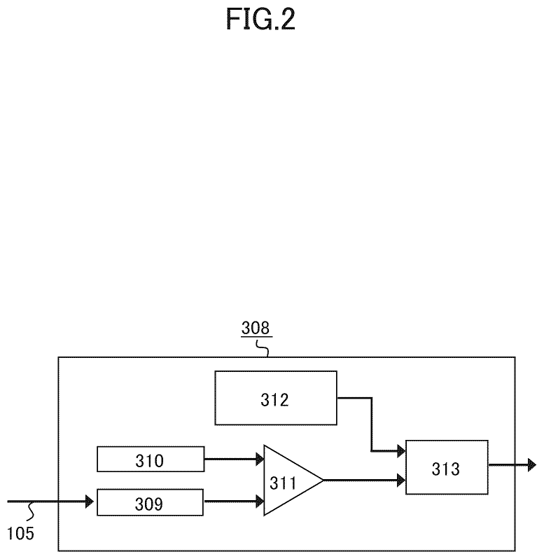

FIG. 2 is a diagram illustrating a configuration example of an A/D converter 308 included in the column circuit 106. The A/D converter 308 includes an analog memory 309, a reference signal generation circuit 310, a comparator 311, a counter 312, and a digital memory 313. The analog memory 309 holds the pixel signal (analog signal) input from the vertical signal line 105. The reference signal generation circuit 310 serving as a reference signal generator generates a reference signal to be used for A/D conversion. The reference signal is a signal whose signal level changes with the lapse of time in an arbitrary voltage region where an A/D conversion result is desired to be acquired. A form of the reference signal is not particularly limited, but for example, a ramp signal whose signal level monotonically increases or monotonically decreases with the lapse of time can be applied.

The comparator 311 includes two input nodes and one output node. One input node of the comparator 311 is connected to an output node of the analog memory 309. The other input node of the comparator 311 is connected to the reference signal generation circuit 310 and receives the reference signal. In a case where a level of the reference signal is lower than a level of a signal output from the analog memory 309, the comparator 311 outputs a signal of an H level. In a case where the level of the reference signal is higher than the level of the signal output from the analog memory 309, the comparator 311 outputs a signal of an L level.

The counter 312 starts a counting operation in synchronization with a timing at which a change in signal level of the reference signal supplied to the comparator 311 starts, and outputs a count signal to the digital memory 313. The digital memory 313 holds the signal input from the counter 312 at a time point at which the output of the comparator 311 is changed from the H level to the L level.

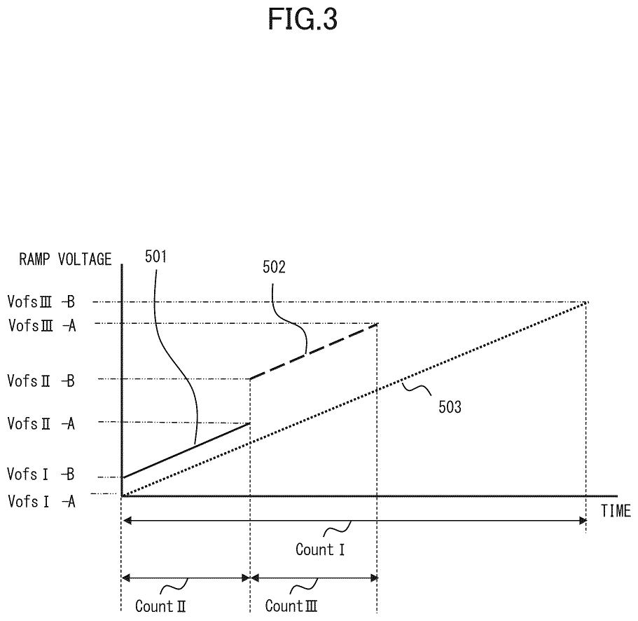

As described below with reference to FIG. 3, when the reference signal is switched from a ramp voltage 501 to a ramp voltage 502, the signal level of the reference signal discontinuously changes. Therefore, a bias value may be added to an output value of the counter 312 in accordance with a switching timing of the ramp voltage. However, in a case where there is no influence on a result of the binarization described below, the counter 312 may be configured to output a count value that continuously increases at a constant rate even at a timing at which the signal level of the reference signal discontinuously changes.

Here, properties of the pixel signal (analog signal) output from each pixel of the radiation detector will be described in order to facilitate understanding of an operation of the A/D converter 308 in a high-speed A/D conversion mode.

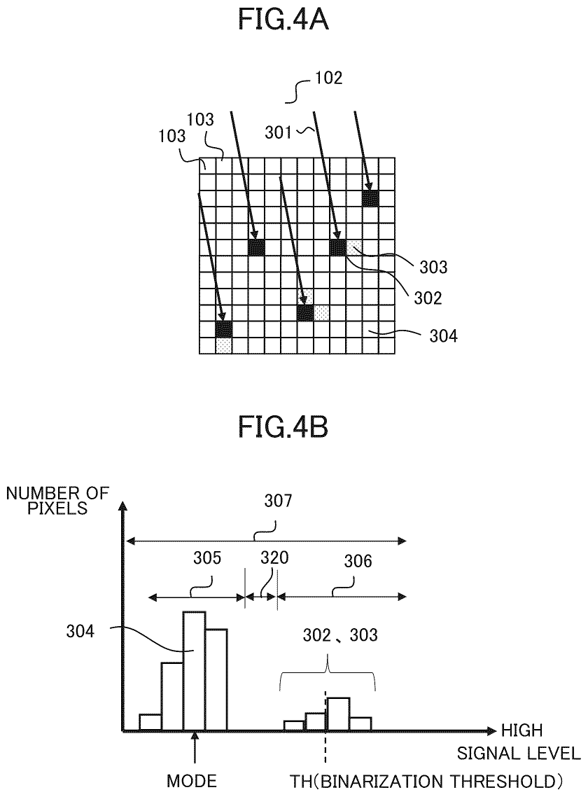

FIG. 4A is a schematic diagram illustrating a situation in which the radiation is applied to the radiation detector. Although the pixel array 102 in which 12×12 pixels 103 are two-dimensionally arranged is illustrated, the number of pixels is not limited to this example, and for example, thousands×thousands of pixels 103 may be provided in order to acquire a high-definition image. Each pixel 103 has a function of converting received radiation into an analog voltage signal and outputting the analog voltage signal as the pixel signal. The pixel 103 may include a light receiving element that directly receives radiation and converts the radiation into a signal, or may include, for example, a scintillator that converts radiation into light like a phosphor and alight receiving element that receives the converted light.

In FIG. 4A, injected radiation 301 is schematically indicated by an arrow. A pixel to which the radiation 301 is directly injected is referred to as an injected pixel 302 for convenience, and is illustrated in black. Furthermore, a pixel to which the radiation 301 is not injected is referred to as a non-injected pixel 304 for convenience, and is illustrated in white. However, even in the case of a pixel to which the radiation 301 is not directly injected, output signals of some pixels adjacent to the injected pixel 302 change due to, for example, generation of signal charges caused by arrival of the radiation via the injected pixel 302. As described above, a pixel to which the radiation is not directly injected and of which an output signal changes due to an influence of the radiation is referred to as an affected pixel 303 for convenience and illustrated in gray.

In order to perform appropriate counting, it is necessary to quickly acquire binarized images of a plurality of frames. At this time, it is necessary to acquire a multi-value pixel signal in which an influence of a temporal change of the background component is reduced for each frame and generate the binarized image by using the multi-value pixel signal. Here, the background component is, for example, a dark current generated in the light receiving element (for example, the photodiode 201 in FIG. 1B) of each pixel, noise caused by a circuit of each pixel, shading corresponding to a position of each pixel, or the like that is superimposed. The background component can change over time due to temporal degradation of a semiconductor element caused by application of radiation over a long period of time, a temperature change of the imaging element 101, or the like.

FIG. 4B is a histogram illustrating an example of a relationship between the level of the pixel signal (analog signal) output from each pixel and the number of pixels when imaging of one frame is performed. A horizontal axis represents an output level of the pixel signal, and a vertical axis represents the number of pixels. In the histogram, two peaks, a peak formed by the non-injected pixel 304 (the left side in the drawing) and a peak formed by the injected pixel 302 and the affected pixel 303 (the right side in the drawing), are formed. Since an injection amount of the radiation 301 injected to the radiation detector changes depending on a state of the imaging target, a height and shape of the peak of the histogram can change according to the state of the imaging target.

Although the pixel signal of the non-injected pixel 304 forms the peak on the left side in the drawing, the non-injected pixel 304 is a pixel to which the radiation 301 is not injected. Therefore, the signal level of the pixel signal can be considered to represent the background component. Since the background components of the same amplitude do not occur in every pixel, the signal levels of the signals (background components) read from the plurality of non-injected pixels 304 are distributed with a range. A signal level corresponding to a peak position of the left peak, that is, a signal level (mode) of a non-injected pixel with the largest number of pixels among the non-injected pixels, can be treated as a representative value of the background component in the image frame.

The signal level of the background component changes over time for various reasons. For example, when an ambient temperature of the device changes or when a temperature rise occurs due to generation of heat from the device itself due to application of radiation, the dark current flowing in the pixel changes, as a result of which the level of the background component included in the pixel signal changes. Then, the shape of the left peak in the histogram also changes, and the signal level corresponding to the mode that is the representative value of the background component can also change.

In this way, the signal levels of the background component are distributed with a range, and the distribution can change over time, but it is possible to specify in advance a voltage range in which the signal level of the mode of the background component can be distributed. For example, the distribution of the signal levels of the background components can be measured in advance in a state where no radiation is applied to the device, and the signal level corresponding to the mode can be detected. Furthermore, it is possible to measure a change in distribution of background levels by changing the ambient temperature or the device temperature in a state where not radiation is applied, and measure a change in signal level corresponding to the mode. Alternatively, it is possible to apply radiation and then stop the application of the radiation, measure a change in distribution of the background levels, and measure a change in signal level corresponding to the mode. By these methods, it is possible to specify a voltage range in which the signal level corresponding to the mode of the background component can be distributed. In FIG. 4B, the range of the signal level in which the mode of the pixel signal of the non-injected pixel 304 can be present is illustrated as a first voltage region 305 in consideration of a temporal change of the background component.

The pixel signals of the injected pixel 302 and the affected pixel 303 form the peak on the right side of the histogram. The signal level of the injected pixel 302 is considered to be obtained by superimposing a radiation signal component generated due to injection of the radiation and the background component. A level of the radiation signal component can change depending on a type of radiation, a radiation application condition such as acceleration energy, a structure of the light receiving element (for example, the photodiode 201 in FIG. 2), a thickness of a substrate, or the like. Even in a case where these conditions are constant, sizes of the generated radiation signal components have a statistical probability distribution and the background components are distributed with a range, and thus, the signal levels of the pixel signals of the injected pixels 302 are distributed with a range.

The signal level of the affected pixel 303 is considered to be obtained by, for example, superimposing an affected component resulting from injection of radiation to an adjacent pixel and the background component. The size of the affected component is not constant, but is larger than the background component. Since the signal levels of the affected component and the background component are distributed with a range, the signal levels of the pixel signals of the affected pixels 303 in which the affected components and the background components are superimposed are distributed with a range.

Since the pixel signals of the injected pixel 302 and the affected pixel 303 forming the peak on the right side of the histogram include the background component that changes over time, the signal levels of the pixel signals can change over time. However, it is possible to specify in advance a voltage range in which the pixel signals of the injected pixel 302 and the affected pixel 303 can be distributed in consideration of the temporal change. For example, a method of measuring in advance distribution of signal levels of an injected pixel and a pixel adjacent to the injected pixel in a state where radiation is applied, a method of measuring a change in distribution of signal levels of an injected pixel and a pixel adjacent to the injected pixel by changing the ambient temperature or the device temperature, and the like are considered. In addition, application of radiation may be continued, and a change in distribution of signal levels of pixels may be measured in a state where characteristics of the semiconductor element are deteriorated due to a total dose effect.

In FIG. 4B, a range including the pixel signals of the injected pixel 302 and the affected pixel 303 is illustrated as a second voltage region 306 in consideration of the temporal change of the background component. As described below, the second voltage region 306 can be set as a region including a binarization threshold TH for generating a favorable binarized image. Since the pixel signals of the injected pixel 302 and the affected pixel 303 have higher signal levels than the mode of the pixel signal of the non-injected pixel 304, the first voltage region 305 and the second voltage region 306 do not overlap each other. In other words, it can be said that the first voltage region 305 and the second voltage region 306 are spaced apart from each other with a third voltage region 320 interposed therebetween.

As described above, it is desirable to acquire a binarized image with high image quality for each frame in order to perform appropriate counting. However, in a case where the signal level of the injected pixel 302 or the affected pixel 303 changes for each frame due to the temporal change of the background component, a magnitude relationship with respect to the binarization threshold TH shifts, which is disadvantageous. Meanwhile, it is desirable to perform imaging at a high frame rate and execute A/D conversion processing in order to perform appropriate counting.

FIG. 3 is a graph illustrating a temporal change of the reference signal (ramp voltage) output from the reference signal generation circuit 310 in the present embodiment. A horizontal axis represents time, and a vertical axis represents voltage. The reference signal generation circuit 310 can operate corresponding to two modes of the high-speed A/D conversion mode and a high-gradation A/D conversion mode.

The high-speed A/D conversion mode is a mode capable of performing A/D conversion at a high frame rate of, for example, several tens of fps to 1500 fps, and is a mode suitable for preprocessing for quickly acquiring a binarized image and performing so-called counting.

The high-gradation A/D conversion mode is a mode suitable for acquiring an image with a high gradation resolution in a wide dynamic range although high speed is not required, such as still image capturing. The A/D converter 308 according to the present embodiment can selectively use the two modes of the high-gradation A/D conversion mode and the high-speed A/D conversion mode according to the application, or may be configured to be able to execute only the high-speed A/D conversion mode.

Reference Numerals 501 and 502 denote the ramp voltages output by the reference signal generation circuit 310 in the high-speed A/D conversion mode, and Reference Numeral 503 denotes a ramp voltage output by the reference signal generation circuit 310 in the high-gradation A/D conversion mode.

In the high-speed A/D conversion mode, during a period of CountII, the ramp voltage 501 sweeps a voltage range from VofsI-B to VofsII-A, and during a period of CountIII, the ramp voltage 502 sweeps a voltage range from VofsII-B to VofsIII-A. Here, sweeping means changing over time between ends of the voltage range or scanning the voltage range.

The voltage range from VofsI-B to VofsII-A corresponds to the first voltage region 305 in FIG. 4B, and the voltage range from VofsII-B to VofsIII-A corresponds to the second voltage region 306. The voltage range from VofsII-A to VofsII-B corresponds to the third voltage region 320. A voltage width of the third voltage region 320 can be, for example, at least twice or more the voltage width corresponding to a quantization resolution in first A/D conversion processing using the ramp voltage 501 and second A/D conversion processing using the ramp voltage 502. In a case where a large voltage width is secured for the third voltage region 320, a processing time in the high-speed A/D conversion mode can be significantly shortened.

In the high-gradation A/D conversion mode, the ramp voltage 503 sweeps a voltage range from VofsI-A to VofsIII-B during a period of CountI. The voltage range from VofsI-A to VofsIII-B corresponds to a dynamic range 307 of the pixel signal (analog) in FIG. 4B.

As can be understood from the configuration of the A/D converter 308 (FIG. 2) and a ramp voltage waveform (FIG. 3), in the high-gradation mode, the voltage range from VofsI-A to VofsIII-B corresponding to the dynamic range 307 of the pixel signal (analog) is swept. Therefore, it takes the period of CountI to perform A/D conversion on pixel signals of one row in one frame.

On the other hand, in the high-speed A/D conversion mode, only the ramp voltage 501 corresponding to the first voltage region 305 and the ramp voltage 502 corresponding to the second voltage region 306 are input to the comparator. That is, multi-value A/D conversion processing is executed on the pixel signals for the first voltage region 305 that always includes the mode of the background level even in a case where there is a temporal change and the second voltage region 306 that includes the pixel signals of the injected pixel 302 and the affected pixel 303. However, for the third voltage region present between the first voltage region 305 and the second voltage region 306, the multi-value A/D conversion processing is not executed on the pixel signal. Therefore, a time required for performing A/D conversion on the pixel signals of one row in one frame is CountII+CountIII, and the A/D conversion processing can be completed in a shorter time than in the high-gradation A/D conversion mode.

As an example, in the case of a radiation detector that detects an electron beam, a scanning time of each lamp voltage per pixel row is preferably about 12 μs for CountI, 6 μs for CountII, and 3 μs for CountIII.

In the present embodiment, the circuit is configured to sequentially execute A/D conversion processing on the first voltage region and the second voltage region by using a single comparator 311 in the high-speed A/D conversion mode. Therefore, it is possible to reduce a chip area and lower a chip price.

In the high-speed A/D conversion mode according to the present embodiment, the background level of the non-injected pixel 304 is acquired as a multi-value digital signal of the first voltage region 305. Furthermore, the signal levels of the injected pixel 302 and the affected pixel 303 are acquired as multi-level digital signals of the second voltage region 306.

The DFE 109 obtains the mode of the background level (multi-value digital signal) obtained from the non-injected pixel 304 of the frame by using the ramp voltage 501 in the high-speed A/D conversion mode, and calculates the mode as the background component in the frame. The DFE 109 can acquire a multi-value pixel signal representing a net signal strength by subtracting the calculated background component from the signal levels (multi-value digital signals) of the injected pixel 302 and the affected pixel 303 obtained using the ramp voltage 502. The DFE 109 can generate a multi-value pixel signal (corrected data) obtained by subtracting the background level and output the multi-value pixel signal to the outside of the imaging element 101.

In the high-speed A/D conversion mode according to the present embodiment, A/D conversion is performed at a higher speed than when the high-gradation A/D conversion mode is executed, and the background component at the time point at which the imaging target is imaged can be easily acquired. Therefore, the radiation signal component from which the background component is excluded can be quickly acquired as the multi-level digital signal. As described below, it is possible to acquire a binarized image with high image quality suitable for counting by using the multi-value digital signal acquired in the high-speed A/D conversion mode.

### Configuration of Radiation Imaging System

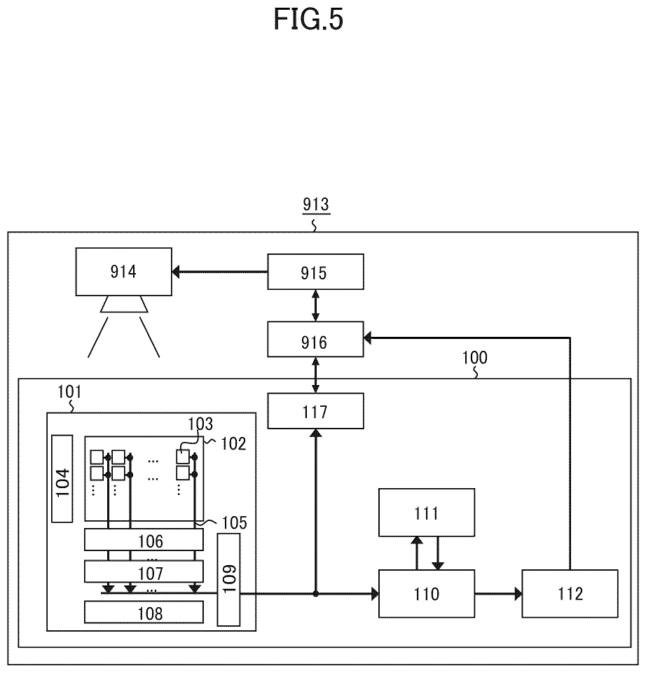

A radiation imaging system 913 incorporating the above-described radiation detector will be described with reference to FIG. 5. FIG. 5 is a schematic block diagram illustrating an example of a configuration of the radiation imaging system 913 according to the present embodiment. The radiation imaging system 913 according to the present embodiment includes the radiation detector 100 illustrated in FIG. 1A, a radiation source 914, an exposure control unit 915, and a computer 916.

The radiation source 914 starts application of radiation according to a command to start exposure from the exposure control unit 915. The radiation extracted from the radiation source 914 is transmitted through the imaging target and directly or indirectly injected to the imaging element 101 of the radiation detector 100. The radiation source 914 stops extraction of the radiation according to a stop command from the exposure control unit 915.

The radiation detector 100 includes the control unit 117 that controls an imaging frame rate and a radiation application rate. The control unit 117 generates a stop signal for stopping application of radiation from the radiation source 914 based on a signal output from the imaging element 101. The stop signal is transmitted to the exposure control unit 915, and the exposure control unit 915 transmits the stop command to the radiation source 914 in response to the transmitted stop signal.

When the application rate of the radiation applied from the radiation source 914 is high, a probability that two or more radiation particles or photons are injected to the same pixel in one frame period of the image increases. In this case, when an analog pixel signal is subjected to A/D conversion to be multi-valued and then binarized with a fixed threshold at the time of acquiring a binary pixel signal, even a pixel to which two or more radiation particles or photons are injected is counted as 1, and thus, a count loss can occur.

Therefore, as a desirable embodiment, the control unit 117 controls the imaging frame rate and the radiation application rate such that the radiation application rate per pixel does not exceed, for example, 0.5 during one frame period (that is, the radiation application rate does not exceed 0.5/pix/frm).

Here, a unit [/pix/frm] is an average value of the number of radiation particles or photons injected per frame and per pixel. In the present embodiment, the radiation application rate is set to 0.5/pix/frm or less. In other words, imaging is performed at such a low application rate that a probability that radiation is injected to one pixel at a certain time is ½ or less. For example, a standard of the application rate in the case of using an X-ray is 0.5 or less as an average value of the number of photons injected per frame and per pixel. A standard of the application rate in the case of using an electron beam is 0.5 or less as an average value of the number of electrons injected per frame and per pixel. In this manner, by performing imaging at a low application rate, it is possible to acquire a binarized image that can reduce the count loss when counting is performed.

The control unit 117 can be implemented by, for example, a programmable logic device (PLD) such as a field programmable gate array (FPGA), an application specific integrated circuit (ASIC), a general-purpose computer in which a program is incorporated, or a combination of all or some thereof.

The computer 916 performs, for example, control of the radiation detector 100 and the exposure control unit 915, and executes processing for receiving radiation image data from the external interface unit 112 and displaying the radiation image data as a radiation image.

The control unit 117 may be provided separately from the radiation detector 100. For example, the computer 916 may have the function of the control unit 117. Furthermore, the computer 916 may function as an input unit for a user to input conditions for capturing a radiation image.

As an example, the exposure control unit 915 includes an exposure switch, and when the exposure switch is turned on by the user, an exposure command is sent from the exposure switch to the radiation source 914, and a start notification indicating the start of application of radiation is sent to the computer 916. The computer 916 receiving the start notification notifies the control unit 117 of the radiation detector 100 of the start of the application of the radiation in response to the start notification. In response to the notification, the control unit 117 controls the imaging element 101 to generate a signal corresponding to the injected radiation.

### Signal Processing Method

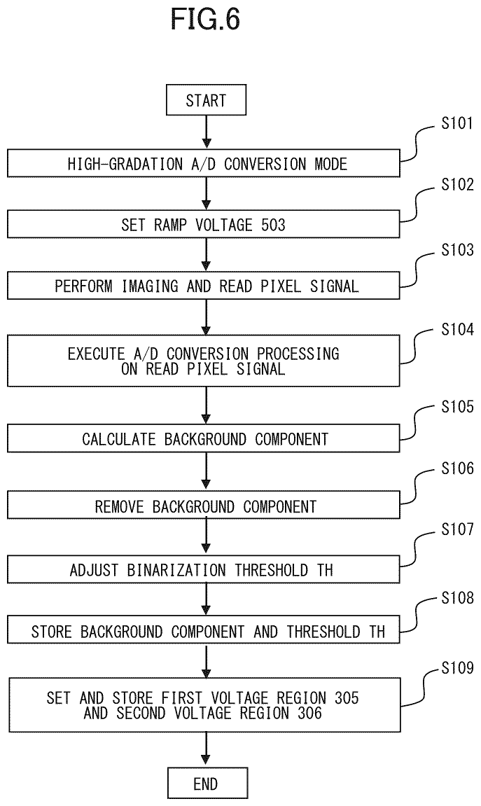

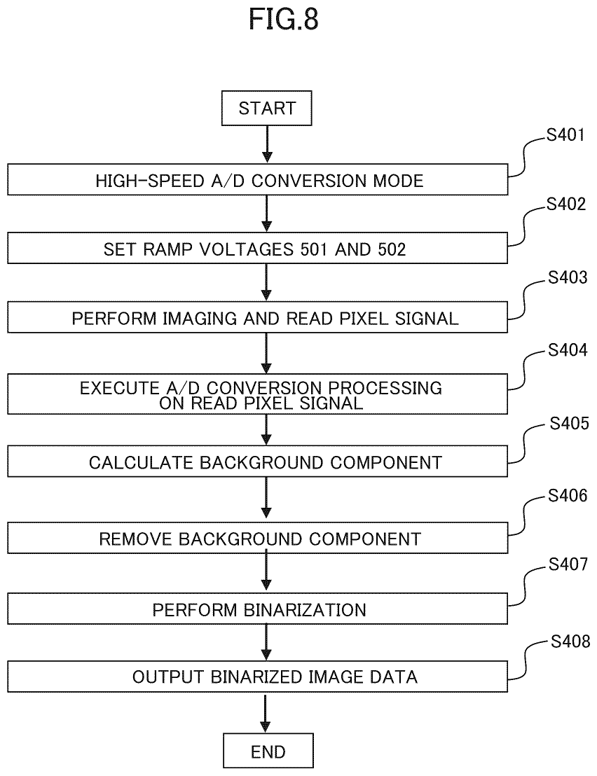

Next, a procedure in which the radiation imaging system 913 according to the present embodiment acquires a multi-value pixel signal in the high-speed A/D conversion mode and acquires and outputs a binarized image suitable for counting based on the multi-value pixel signal will be described. FIG. 6 is a flowchart illustrating a procedure of setting processing executed by the radiation imaging system 913 before executing the high-speed A/D conversion mode, and FIG. 8 is a flowchart illustrating a procedure of processing of imaging the imaging target in the high-speed A/D conversion mode and acquiring a binarized image.

First, the procedure of the setting processing executed before the high-speed A/D conversion mode is executed will be described with reference to FIG. 6. In step S101, the computer 916 instructs the control unit 117 to shift to the high-gradation A/D conversion mode.

In step S102, the control unit 117 sets the reference signal generation circuit 310 such that the ramp voltage 503 (FIG. 3) can be output. The reference signal generation circuit 310 can include, for example, a memory, a logic circuit, a D/A conversion circuit, and the like, and the control unit 117 can store waveform data of the ramp voltage 503 in the memory.

In step S103, imaging and reading of the pixel signals are performed. Specifically, the computer 916 transmits an instruction to capture a radiation image to the exposure control unit 915 and the control unit 117 of the radiation detector 100. The exposure control unit 915 drives the radiation source 914 to apply radiation necessary for capturing the radiation image. In synchronization with the application, the control unit 117 of the radiation detector 100 outputs a control signal for imaging of one frame to the imaging element 101.

In step S104, the A/D converter 308 included in the column circuit 106 executes A/D conversion processing on the pixel signals (analog) sequentially read in units of rows from the pixel array 102 in the high-gradation mode. An A/D conversion processing result is temporarily stored in the column memory 107. The multi-value pixel signal stored in the column memory 107 is transmitted to the DFE 109 by the horizontal scanning circuit 108 and stored in the memory included in the DFE 109. The image signals are sequentially read in units of rows, and the A/D conversion processing result of one frame image is stored in the DFE 109.

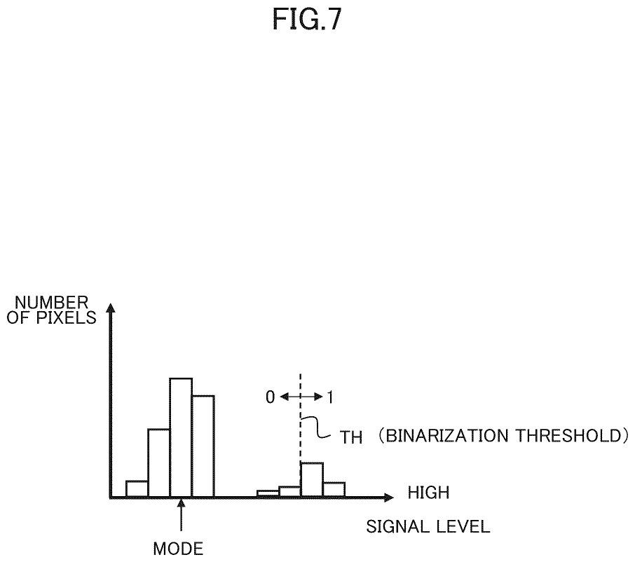

In step S105, the DFE 109 extracts the background component in the frame by using the multi-value pixel signal for one frame. Although the number of pixels for each signal level is illustrated as a histogram in FIG. 7, the DFE 109 calculates, for example, the signal level of the mode with the largest number of pixels as the background component.

In step S106, the DFE 109 subtracts the calculated background level from the multi-value pixel signal for one frame. The multi-value pixel signal for one frame from which the background level has been removed is transmitted to the output signal processing unit 110 and stored in the memory unit 111.

In step S107, the output signal processing unit 110 binarizes the multi-value pixel signal for one frame from which the background level has been removed with the binarization threshold TH, and displays the binarized image on a display unit of the radiation imaging system 913. The user checks the binarized image while changing the binarization threshold TI, and adjusts the binarization threshold TH so as to obtain the binarized image suitable for counting.

In step S108, the output signal processing unit 110 stores the background component (mode) acquired by the DFE 109 in step S106 and the binarization threshold TH acquired in step S107 in the storage unit.

As described above, the background component (mode) corresponding to the captured image of one frame and the binarization threshold TH suitable for acquiring the binarized image suitable for counting are acquired. The radiation imaging system 913 executes similar processing on a plurality of captured images, and acquires and stores the background component (mode) and the binarization threshold TH corresponding to each captured image. For example, imaging is performed by changing the ambient temperature or device temperature, imaging is performed by changing a state of the imaging object, or imaging is performed in a state where the characteristics of the semiconductor element are deteriorated due to the total dose effect by continuing the application of the radiation, and the background component (mode) and the binarization threshold TH are acquired. In this manner, when imaging is performed in different situations, the signal level of the background component (mode) and the binarization threshold TH change over time according to the situation.

In step S109, the output signal processing unit 110 calculates a variation range of the signal level of the background component (mode) and a variation range of the binarization threshold TH. Then, the output signal processing unit 110 sets the first voltage region 305 illustrated in FIG. 4B so as to include the variation range of the signal level of the background component (mode). In addition, the output signal processing unit 110 sets the second voltage region 306 so as to include the variation range of the binarization threshold TH. The output signal processing unit 110 sets the first voltage region 305 and the second voltage region 306 so as not to overlap each other and to be spaced apart from each other with the third voltage region 320 interposed therebetween. The output signal processing unit 110 stores the set result in the memory of the control unit 117. As described above, the setting processing executed before the high-speed A/D conversion mode is executed is completed.

Next, a procedure for imaging the imaging target in the high-speed A/D conversion mode and acquiring the binarized image will be described with reference to a flowchart of FIG. 8.

In step S401, the computer 916 instructs the control unit 117 to shift to the high-speed A/D conversion mode.

In step S402, the reference signal generation circuit 310 is set. The control unit 117 reads the stored first voltage region 305 and second voltage region 306, and generates waveform data of the ramp voltage 501 and the ramp voltage 502 illustrated in FIG. 3. The reference signal generation circuit 310 can include, for example, a memory, a logic circuit, a D/A conversion circuit, or the like, and the generated waveform data can be stored in the memory of the reference signal generation circuit 310. As a result, the reference signal generation circuit 310 is set to be able to output the ramp voltage 501 during the period of CountII and output the ramp voltage 502 during the period of CountII illustrated in FIG. 3.

In step S403, when imaging is started, electric charges are accumulated in each pixel 103 of the pixel array 102 in a state where the radiation is applied from the radiation source 914 of the radiation imaging system, and an analog pixel signal is read from the pixel 103 of the pixel array 102.

In step S404, the A/D converter 308 included in the column circuit 106 executes A/D conversion processing on the pixel signals (analog) sequentially read in units of rows from the pixel array 102 in the high-speed A/D conversion mode. An A/D conversion processing result is temporarily stored in the column memory 107. The multi-value pixel signal stored in the column memory 107 is transmitted to the DFE 109 by the horizontal scanning circuit 108 and stored in the memory included in the DFE 109. The image signals are sequentially read in units of rows, and the A/D conversion processing result of one frame image is stored in the DFE 109.

In step S405, the DFE 109 extracts the background component in the frame by using the multi-value pixel signal for one frame (background level acquisition step). Although the number of pixels for each signal level is illustrated as a histogram in FIG. 7, the DFE 109 calculates, for example, the signal level of the mode with the largest number of pixels as the background component.

In step S406, the DFE 109 subtracts the calculated background component (background level) from the multi-value pixel signal for one frame. The multi-value pixel signal for one frame from which the background component has been removed is transmitted to the output signal processing unit 110 and stored in the memory unit 111.

In step S407, the output signal processing unit 110 binarizes the multi-value pixel signal for one frame from which the background component (background level) has been removed with the binarization threshold TH to acquire the binarized image. Data of the acquired binarized image can be stored in the memory unit 111. As the binarization threshold TH, a value acquired in the processing described with reference to FIG. 6 may be used. For example, in the processing of FIG. 6, a table in which the background level (mode) acquired in advance from a plurality of captured images is associated with the binarization threshold is created and stored in the output signal processing unit 110. The output signal processing unit 110 can determine (correct) the binarization threshold TH suitable for the current captured image with reference to the background level in the current captured image calculated by the DFE 109 in step S405 and the table.

In step S408, the data of the acquired binarized image can be output to the computer 916 or another external device (not illustrated) via the external interface unit 112. The radiation imaging system 913 can display the binarized image on a display device (not illustrated). By outputting the captured multi-valued image data as the binarized image data suitable for counting instead of directly outputting the multi-valued image data to the outside, it is possible to reduce the number of output ports and reduce a clock rate of data communication. Furthermore, it is also possible to reduce a load of data processing of an external processing device. Therefore, the cost of the entire system can be reduced.

In the above description, the DFE 109 executes the processing of calculating and removing the background component, and the output signal processing unit 110 performs the binarization. However, the present embodiment is not limited thereto. For example, a part of or the entire processing described above may be executed by the DFE 109, by the control unit 117, by the output signal processing unit 110, by the computer 916, or by the external processing device. In addition, a control program for causing a processing device such as a computer to execute a part of or the entire processing described above and a computer-readable storage medium storing the control program are also included in the embodiment of the present disclosure.

For example, in a case where all the steps of processing are executed by the DFE 109, a function of calculating, removing, and binarizing the background component can be implemented on-chip in the imaging element 101, that is, on the same substrate as the pixel array 102, the column circuit 106, and the like. As a result, the subsequent processing downstream of the output signal processing unit 110 can be simplified. In addition, downsizing and cost reduction of the system are possible.

### Second Embodiment

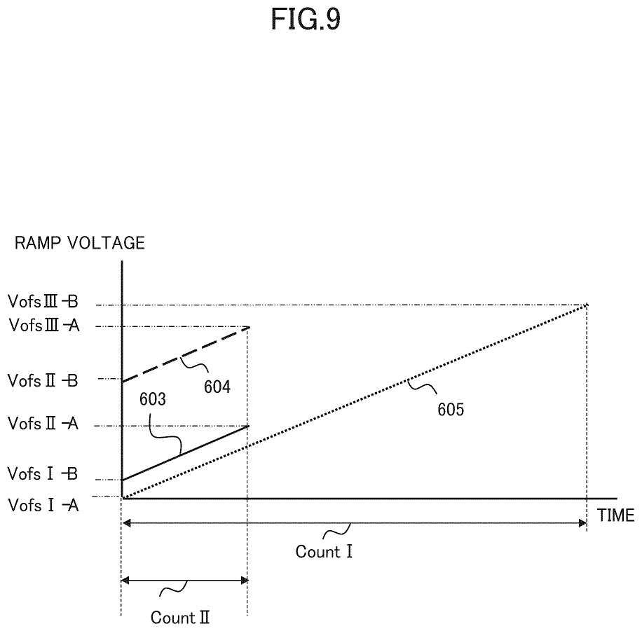

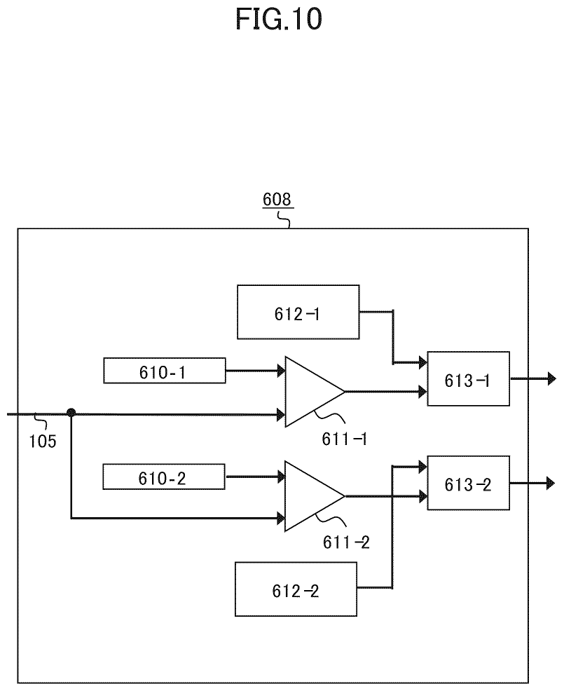

A radiation detector, a radiation imaging system, and the like according to a second embodiment will be described. A description of matters common to the first embodiment will be simplified or omitted. The radiation detector according to the present embodiment is also similar to that of the first embodiment in that the radiation detector can operate in a high-speed A/D conversion mode. The present embodiment is different from the first embodiment in a waveform of a reference signal when operating in the high-speed A/D conversion mode. FIG. 9 illustrates an example of the waveform of the reference signal according to the present embodiment, and FIG. 10 illustrates an example of a configuration of an A/D converter 608 according to the present embodiment.

FIG. 10 is a diagram illustrating a configuration example of the A/D converter 608 included in a column circuit 106. The A/D converter 608 includes a reference signal generation circuit 610-1, a reference signal generation circuit 610-2, a comparator 611-1, a comparator 611-2, a counter 612-1, a counter 612-2, a digital memory 613-1, and a digital memory 613-2.

The reference signal generation circuit 610-1 and the reference signal generation circuit 610-2 serving as reference signal generation units generate reference signals for use in A/D conversion. The reference signal generation circuit 610-1 outputs a first ramp voltage 603 illustrated in FIG. 9 to the comparator 611-1, and the reference signal generation circuit 610-2 outputs a second ramp voltage 604 to the comparator 611-2.

A vertical signal line 105 is connected to the comparator 611-1 and the comparator 611-2, and each comparator compares a pixel signal input from the vertical signal line 105 with the reference signal. Each comparator outputs a signal of an H level in a case where a level of the reference signal is lower than a level of the pixel signal, and outputs a signal of an L level in a case where the level of the reference signal is higher than the level of the pixel signal.

The counter 612-1 starts a counting operation in synchronization with a timing at which a change in signal level of the reference signal supplied from the reference signal generation circuit 610-1 to the comparator 611-1 starts, and outputs a count signal to the digital memory 613-1. The digital memory 613-1 holds the signal input from the counter 612-1 at a time point at which the output of the comparator 611-1 is changed from the H level to the L level.

The counter 612-2 starts a counting operation in synchronization with a timing at which a change in signal level of the reference signal supplied from the reference signal generation circuit 610-2 to the comparator 611-2 starts, and outputs a count signal to the digital memory 613-2. The digital memory 613-2 holds the signal input from the counter 612-2 at a time point at which the output of the comparator 611-2 is changed from the H level to the L level.

As described with reference to FIG. 9, the ramp voltage 603 output from the reference signal generation circuit 610-1 and the ramp voltage 604 output from the reference signal generation circuit 610-2 simultaneously start sweeping with different voltages as starting points. Therefore, the output value of the counter 612-2 may be a value obtained by adding a bias value to the output value of the counter 612-1 according to a voltage difference between the ramp voltage 603 and the ramp voltage 604. However, in a case where there is no influence on a result of binarization described below, the bias value does not have to be added, and in this case, the output of one counter may be supplied to both the digital memory 613-1 and the digital memory 613-2.

FIG. 9 is a graph illustrating a temporal change of a ramp signal (ramp voltage) output from the reference signal generation circuit in the present embodiment. A horizontal axis represents time, and a vertical axis represents voltage. The reference signal generation circuit can operate corresponding to two modes of the high-speed A/D conversion mode and a high-gradation A/D conversion mode.

The high-speed A/D conversion mode is a mode capable of performing A/D conversion at a high frame rate of, for example, several tens of fps to 1500 fps, and is a mode suitable for quickly acquiring a binarized image and performing so-called counting. The high-gradation A/D conversion mode is suitable for acquiring an image with a high gradation resolution in a wide dynamic range although high speed is not required, such as still image capturing. The A/D converter 608 according to the present embodiment can selectively use the two modes of the high-gradation A/D conversion mode and the high-speed A/D conversion mode according to the application, or may be configured to be able to execute only the high-speed A/D conversion mode.

In the high-speed A/D conversion mode, the reference signal generation circuit 610-1 outputs the ramp voltage 603, and the reference signal generation circuit 610-2 outputs the ramp voltage 604. In the high-gradation A/D conversion mode, the reference signal generation circuit 610-1 or the reference signal generation circuit 610-1 outputs a ramp voltage 605.

In the high-speed A/D conversion mode, during a period of CountII, the ramp voltage 603 sweeps a voltage range from VofsI-B to VofsII-A, and the ramp voltage 604 sweeps a voltage range from VofsII-B to VofsIII-A. Here, sweeping means changing over time between ends of the voltage range or scanning the voltage range.

The voltage range from VofsI-B to VofsII-A corresponds to a first voltage region 305 in FIG. 4B, and the voltage range from VofsI-B to VofsIII-A corresponds to a second voltage region 306. The voltage range from VofsII-A to VofsII-B corresponds to a third voltage region 320.

In the high-gradation A/D conversion mode, the ramp voltage 605 sweeps a voltage range from VofsI-A to VofsIII-B during a period of CountI. The voltage range from VofsI-A to VofsIII-B corresponds to a dynamic range 307 of the pixel signal (analog) in FIG. 4B.

As can be understood from the configuration of the A/D converter 608 (FIG. 10) and a ramp voltage waveform (FIG. 9), in the high-gradation mode, the voltage range from VofsI-A to VofsIII-B corresponding to the dynamic range 307 of the pixel signal (analog) is swept. Therefore, it takes the period of CountI to perform A/D conversion on pixel signals of one row in one frame.

On the other hand, in the high-speed A/D conversion mode, the ramp voltage 603 corresponding to the first voltage region 305 and the ramp voltage 604 corresponding to the second voltage region 306 are input to the comparator 611-1 and the comparator 611-2 in parallel. That is, multi-value A/D conversion processing is executed in parallel on the pixel signals for the first voltage region 305 that always includes a mode of a background level even in a case where there is a temporal change and the second voltage region 306 that includes pixel signals of an injected pixel 302 and an affected pixel 303. However, the multi-value A/D conversion processing is not executed on each pixel signal in the third voltage region between the first voltage region 305 and the second voltage region 306. Therefore, a time required for performing A/D conversion on the pixel signals of one row in one frame is CountII, and the A/D conversion processing can be performed in a shorter time than in the high-gradation A/D conversion mode.

As an example, in the case of a radiation detector that detects an electron beam, a scanning time of each lamp voltage per pixel row is preferably about 12 μs for CountI and 6 μs for CountII.

Since the configuration of the radiation imaging system and the signal processing method are common to those of the first embodiment in many points, a description thereof will be omitted. In the present embodiment, an A/D conversion result for the first voltage region 305 is stored in the digital memory 613-1, and an A/D conversion result for the second voltage region 306 is stored in the digital memory 613-2. Therefore, when calculating the background level, a DFE 109 may extract a mode of a multi-value pixel signal stored in the digital memory 613-1.

Similarly to the first embodiment, in the high-speed A/D conversion mode according to the present embodiment, A/D conversion is performed at a higher speed than when the high-gradation A/D conversion mode is executed, and the background component at a time point at which an imaging target is imaged can be easily acquired. Therefore, a radiation signal component from which the background component is excluded can be quickly acquired as a multi-level digital signal. In addition, similarly to the first embodiment, it is possible to acquire a binarized image with high image quality suitable for counting by using the multi-value digital signal acquired in the high-speed A/D conversion mode.

### Third Embodiment

A radiation detector, a radiation imaging system, and the like according to a third embodiment will be described. A description of matters common to the first or second embodiment will be simplified or omitted. The radiation detector according to the present embodiment is also similar to those of the first and second embodiments in that the radiation detector can operate in a high-speed A/D conversion mode capable of executing A/D conversion processing at a high speed. In the present embodiment, a reference signal illustrated in FIG. 3 is used in the A/D conversion processing similarly to the first embodiment, but a processing method for binarizing and outputting a multi-value pixel signal is different from that of the first embodiment.

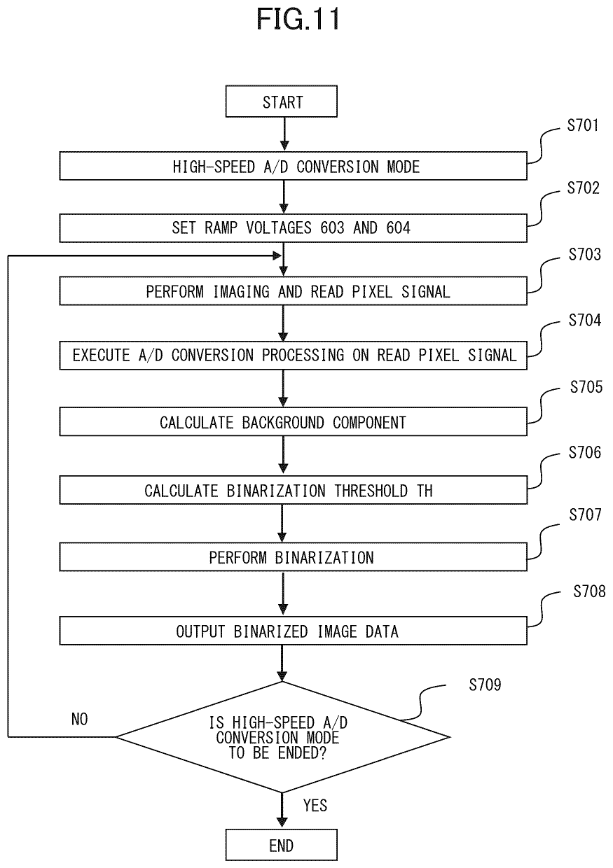

FIG. 11 is a flowchart illustrating a procedure of processing executed by the radiation detector according to the present embodiment. Steps S701 to S705 are similar to steps S401 to S405 described in the first embodiment (FIG. 8).

In the present embodiment, in step S706, a binarization threshold TH is calculated using a background component extracted in step S705 (background level acquisition step). Steps S707 to S708 are similar to steps S407 to S408 described in the first embodiment (FIG. 8).

In the present embodiment, after step S708 is executed, it is determined in step S709 whether or not to end the high-speed A/D conversion mode. In a case where it is determined not to end the processing (step S709: NO), the processing returns to step S703, and steps S703 to S708 are repeatedly executed. As a result, for example, even in a case where a cumulative dose of radiation increases and the background component changes while a moving image is continuously captured, the binarization threshold TH corresponding thereto can be set. That is, in the present embodiment, even in a case where a background level changes, it is possible to output a binary pixel signal following the change of the background level by shifting the binarization threshold TH according to an amount of the change. Instead of shifting the binarization threshold TH in step 706, a ramp voltage 501 and a ramp voltage 502 may be shifted in the next frame by an amount corresponding to the amount of change.

Similarly to the first embodiment, in the high-speed A/D conversion mode according to the present embodiment, A/D conversion is performed at a higher speed than when a high-gradation A/D conversion mode is executed, and the background component at a time point at which an imaging target is imaged can be easily acquired. Therefore, a radiation signal component from which the background component is excluded can be quickly acquired as a multi-level digital signal. In addition, similarly to the first embodiment, it is possible to acquire a binarized image with high image quality suitable for counting by using the multi-value digital signal acquired in the high-speed A/D conversion mode.

### Fourth Embodiment

A radiation detector, a radiation imaging system, and the like according to a fourth embodiment will be described. A description of matters common to any one of the above-described embodiments will be simplified or omitted. The radiation detector according to the present embodiment is also similar to those of other embodiments in that the radiation detector can operate in a high-speed A/D conversion mode capable of executing A/D conversion processing at a high speed. In the other embodiments, when a background component is extracted, a mode of a signal level in a first voltage region is extracted for all pixels in one frame and treated as the background component of all the pixels in the frame. In the present embodiment, the background component for a certain pixel is extracted based on pixel signals of surrounding pixels.

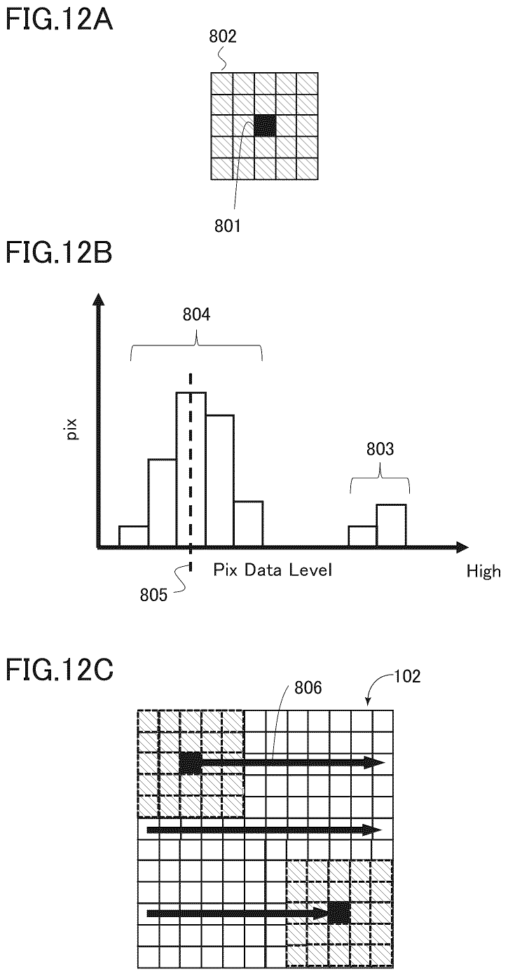

FIGS. 12A to 12C are diagrams illustrating an arithmetic filter used in a processing method according to the present embodiment. FIG. 12A is a diagram illustrating a filter region of the arithmetic filter. FIG. 12B is a diagram illustrating an example in which a value of each pixel signal in a region to which the arithmetic filter is applied is represented as a histogram.

In the other embodiments, the background component corresponding to the entire screen of one frame is calculated, but in the present embodiment, a local background component is obtained by calculating the background component for each pixel.

Specifically, for a target pixel 801 (a pixel of interest) for which a background value is desired to be calculated, a range 802 of a plurality of pixels around the target pixel 801 is set as a size of the arithmetic filter. A median or mode calculated from the value of each pixel signal in the filter region of the arithmetic filter is set as a background component 805 of the target pixel 801.

As illustrated in FIG. 12B, when the values of the pixel signals in the filter region are represented as a histogram, a pixel signal 803 of a pixel to which radiation is injected and a pixel signal 804 of a pixel to which no radiation is injected are distributed separately in two regions. As described in the first embodiment, in a case where imaging is performed at a low application rate, the application rate being a radiation application rate per pixel that does not exceed, for example, 0.5 during one frame period, the number of pixels to which no radiation is injected is usually larger than the number of pixels to which the radiation is injected. Therefore, the median or mode of the multi-valued pixel signal 803 and pixel signal 804 can be set as the background component 805.

Target pixels are sequentially changed on a pixel array 102 to two-dimensionally sweep the arithmetic filter in a sweeping direction 806 indicated by an arrow in FIG. 12C, and the background component is calculated for each pixel by the above-described method. The sweeping direction may be either a column or a row, or may be set according to compatibility with a processing circuit.

In the example of FIG. 12A, the size of the arithmetic filter is 5×5 pixels, but the present technology is not limited to this example. The size of the filter may be three pixels or more, and may be appropriately determined according to a function of a DFE 109. For example, in a case where a processing function in the DFE 109 is in units of one row, the size of the filter is 1×n (n is 3 or more and less than the number of pixels in one row). Alternatively, in a case where processing of a plurality of rows is possible, the size of the filter may be m×n like the above-described 5×5 rectangular region.

The size of the filter is set in consideration of a spatial frequency of a main factor that causes non-uniformity of the background component. Generally, in a case where the size of the filter is reduced, local unevenness and shading components included in the background component can be easily extracted. On the other hand, in a case where the size of the filter is larger, a possibility that a value calculated as the background component greatly deviates from the actual background component is reduced.

In a case where the size of the filter is increased, a circuit block having a memory function such as a line memory or a frame memory may be separately provided in an imaging element or outside the imaging element to perform the above arithmetic operation. The line memory is a memory capable of storing pixel signals corresponding to pixels of one row. The frame memory is a memory capable of storing pixel signals for one frame (pixel signals of the pixels of the pixel array 102). In a case where processing is executed in the imaging element, simultaneity between imaging and display is improved. Further, since the processing can be executed without increasing the number of components, it is possible to reduce the size and the price of the system.

For the A/D conversion processing, the high-speed A/D conversion mode of any one of the first to third embodiments is executed. Also in the present embodiment, the background component and a pixel signal component can be acquired using a plurality of pixel signals of the same frame. Similarly to the first to third embodiments, in the high-speed A/D conversion mode according to the present embodiment, A/D conversion is performed at a higher speed than when a high-gradation A/D conversion mode is executed, and the background component at a time point at which an imaging target is imaged can be easily acquired. Therefore, a radiation signal component from which the background component is excluded can be quickly acquired as a multi-level digital signal. In addition, similarly to the first embodiment, it is possible to acquire a binarized image with high image quality suitable for counting by using the multi-value digital signal acquired in the high-speed A/D conversion mode.

### Fifth Embodiment

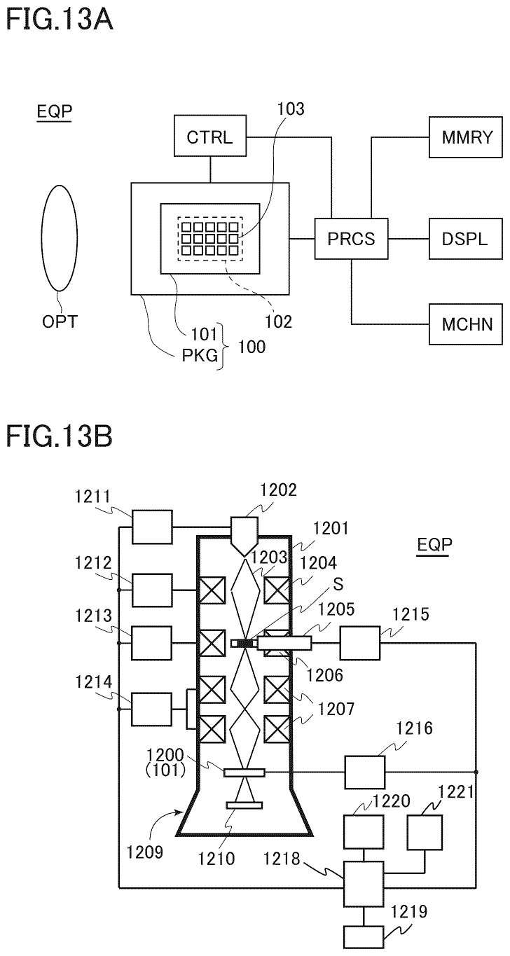

As a fifth embodiment, another example of a radiation imaging system incorporating a radiation detector will be described with reference to FIGS. 13A and 13B.

FIG. 13A illustrates equipment EQP serving as a radiation imaging system including a radiation detector 100. The radiation detector 100 includes a package PKG for mounting an imaging element 101 in addition to the imaging element 101 which is a semiconductor device.

The package PKG may include abase to which the imaging element 101 is fixed, a lid such as glass facing the imaging element 101, and a connection member such as a bonding wire or a bump that connects a terminal provided on the base and a terminal provided on the imaging element 101. The imaging element 101 includes a pixel array 102 in which pixels 103 are arranged in a matrix and a peripheral region around the pixel array 102. A peripheral circuit (for example, a vertical scanning circuit 104 and a DFE 109) can be provided in the peripheral region.

The equipment EQP may further include at least one of an optical system OPT, a control device CTRL, a processing device PRCS, a display device DSPL, a storage device MMRY, and a mechanical device MCHN. The optical system OPT forms an image of radiation on the radiation detector 100, and is, for example, a lens, a shutter, or a mirror. The optical system OPT may form an image of a particle beam such as an electron beam or a proton beam on the radiation detector 100 according to a type of radiation to be handled. The control device CTRL controls the radiation detector 100, and is, for example, an ASIC. The processing device PRCS processes a signal output from the radiation detector 100, and is a device such as a central processing unit (CPU) or an ASIC for configuring an analog front end (AFE) or a digital front end (DFE). The display device DSPL is an electroluminescence (EL) display device or a liquid crystal display device that displays information obtained by the radiation detector 100 in a form of a visible image or the like. The storage device MMRY is a magnetic device or a semiconductor device that stores information obtained by the radiation detector 100. The storage device MMRY is a volatile memory such as a static random-access memory (SRAM) or a dynamic random-access memory (DRAM), or a nonvolatile memory such as a flash memory or a hard disk drive. The mechanical device MCHN includes a movable unit such as a motor or an engine, or a propulsion unit.

The equipment EQP displays a signal output from the radiation detector 100 on the display device DSPL or transmits the signal to the outside by a communication device (not illustrated) included in the equipment EQP Therefore, the equipment EQP preferably further includes the storage device MMRY and the processing device PRCS separately from a storage circuit and an arithmetic circuit of the radiation detector 100. The mechanical device MCHN may be controlled based on a signal output from the radiation detector 100.

The equipment EQP illustrated in FIG. 13A may be medical equipment such as an endoscope or radiodiagnosis equipment, measurement equipment such as a distance measurement sensor, or analytical equipment such as an electron microscope.

FIG. 13B is a schematic diagram illustrating a configuration of a transmission electron microscope (TEM) as an example of the equipment EQP The equipment EQP serving as an electron microscope includes an electron beam source 1202 (electron gun), an application lens 1204, a vacuum chamber 1201 (lens barrel), an objective lens 1206, a magnifying lens system 1207, and a camera 1209 serving as the radiation detector 100.

The electron beam 1203, which is an energy beam emitted from the electron beam source 1202, is focused by the application lens 1204 and is applied to a sample S serving as an analysis target held by a sample holder. A space through which the electron beam 1203 passes is formed by the vacuum chamber 1201 (lens barrel), and the space is held in vacuum. The radiation detector 100 is disposed to face the vacuum space through which the electron beam 1203 passes. The electron beam 1203 transmitted through the sample S is enlarged by the objective lens 1206 and the magnifying lens system 1207 and projected onto the radiation detector 100. An electron optical system for applying the electron beam to the sample S is referred to as an application optical system, and an electron optical system for forming an image of the electron beam transmitted through the sample S on the radiation detector 100 is referred to as an imaging optical system.

The electron beam source 1202 is controlled by an electron beam source control device 1211. The application lens 1204 is controlled by an application lens control device 1212. The objective lens 1206 is controlled by an objective lens control device 1213. The magnifying lens system 1207 is controlled by a magnifying lens system control device 1214. A control mechanism 1205 of the sample holder is controlled by a holder control device 1215 that controls a drive mechanism of the sample holder.

The electron beam 1203 transmitted through the sample S is detected by a direct detector 1200 of the camera 1209. An output signal from the direct detector 1200 is processed by a signal processing device 1216 and an image processing device 1218 serving as the processing devices PRCS to generate an image signal. The generated image signal (transmitted electron image) is displayed on an image display monitor 1220 and an analysis monitor 1221 corresponding to the display device DSPL.

The camera 1209 is provided below the equipment EQP The camera 1209 includes the direct detector 1200 (direct electron detector). The direct detector 1200 corresponds to the imaging element 101. The direct detector 1200 is provided in the camera 1209 such that at least a part of the camera 1209 is exposed to the vacuum space formed by the vacuum chamber 1201.

Each of the electron beam source control device 1211, the application lens control device 1212, the objective lens control device 1213, the magnifying lens system control device 1214, and the holder control device 1215 is connected to the image processing device 1218. As a result, data can be exchanged with each other in order to set imaging conditions of the electron microscope. For example, an application rate of the electron beam can be set so as to be 0.5 electron/pix/frm or less. In this case, the electron beam source control device 1211 and the image processing device 1218 function as a control unit that controls a radiation application rate. Drive control of the sample holder and observation conditions of each lens can be set according to a signal from the image processing device 1218.

An operator prepares the sample S to be imaged, and sets imaging conditions by using an input device 1219 connected to the image processing device 1218. Predetermined data is input to each of the electron beam source control device 1211, the application lens control device 1212, the objective lens control device 1213, and the magnifying lens system control device 1214, and a desired acceleration voltage, magnification, and observation mode are obtained. In addition, the operator inputs conditions such as the number of consecutive visual field images, an imaging start position, and a movement speed of the sample holder to the image processing device 1218 by using the input device 1219 such as a mouse, a keyboard, or a touch panel. Alternatively, the image processing device 1218 may automatically set the conditions without depending on the operator's input. The radiation imaging system described in the fifth embodiment is merely an example, and the radiation detector described in the first to fourth embodiments may be applied to other systems.

Furthermore, in the above embodiments, an example in which a method of performing imaging and obtaining a background component of a pixel signal at the same time is applied to the radiation detector or the radiation imaging system has been described. The present technology is not limited thereto, and for example, the method described in each embodiment may be applied to a detector using a single photon avalanche diode (SPAD) and an imaging system including the same. As a result, it is possible to obtain a background component that is simultaneous with imaging and remove the background component from image data.

### Other Embodiments

The present technology is not limited to the embodiments described above, and many modifications can be made within the technical idea of the present disclosure. For example, all or some of the different embodiments described above may be combined and implemented.

In order to calculate the background component, pixel signals of all pixels of one frame image may be used, pixel signals of one row may be used, or pixel signals of pixels around a specific pixel may be used. In this case, the waveform of the reference voltage used in the high-speed A/D conversion mode may be as illustrated in FIG. 3 or FIG. 9.

As a method of calculating the background component, a method of calculating the median value or average value may be used in addition to a method of extracting the mode of the histogram. As a method of calculating the median value, a known algorithm can be used. For example, in the case of calculating the median value of the pixel signals for each row, the pixel signals for each row may be sorted in descending order by quick sorting or the like, and then a value of a middle rank may be selected from the sorted arrangement. Alternatively, a fast algorithm known as the median of the median (quick select) may be applied.

The background component may be calculated based only on the pixel signal included in the first voltage region 305, or may be calculated using both the pixel signal included in the first voltage region 305 and the pixel signal included in the second voltage region 306.

The imaging element 101 may be configured to be able to execute only the high-speed A/D conversion mode, or may be configured to be able to execute both the high-speed A/D conversion mode and the high-gradation A/D conversion mode. Alternatively, the imaging element 101 may execute another A/D conversion mode and the high-speed A/D conversion mode.

The A/D converter can adopt a successive approximation type in addition to a slope type.

The reference signal generated by the reference signal generation circuit is not necessarily a waveform that continuously changes over time, and may be a signal that changes stepwise. In addition, a change in signal level is not necessarily linear with respect to time, and may be curved with respect to time. In the examples of FIGS. 3 and 9, the ramp voltages for scanning the first voltage region and the second voltage region are voltage signals having substantially equal slopes of voltage change with respect to time, but the ramp voltages may be voltage signals having different slopes of voltage change with respect to time.

The first voltage region 305 and the second voltage region 306 do not have to be subjected to A/D conversion with equal quantization resolution. In a case where the slope of the ramp voltage sweeping the first voltage region 305 and the slope of the ramp voltage sweeping the second voltage region 306 are made equal and a clock rate of the counter is made constant, the first voltage region 305 and the second voltage region 306 can be subjected to A/D conversion with equal quantization resolution. On the other hand, in a case where the slope of the ramp voltage or the clock rate of the counter is different between the first voltage region 305 and the second voltage region 306, A/D conversion can be performed with different quantization resolutions.

The conversion element included in the pixel of the radiation detector may be a conversion element formed on a semiconductor substrate such as silicon, or may be a conversion element formed of cadmium telluride or cadmium zinc telluride.

The present disclosure can also be implemented by processing in which a program for implementing one or more functions of the embodiments is supplied to a system or a device via a network or a storage medium, and one or more processors in a computer of the system or the device read and execute the program. The present technology can also be implemented by a circuit (for example, an ASIC) that implements one or more functions.

According to the present disclosure, it is possible to quickly acquire a background component at a time point at which a target object is imaged by applying radiation even in a case where the background component such as a dark current changes over time.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-215170, filed Dec. 20, 2023, which is hereby incorporated by reference herein in its entirety.

What is claimed is:

1. A radiation detector comprising:
a plurality of pixels, each pixel being configured to detect radiation and output voltage signal;
an A/D converter configured to execute first A/D conversion processing of comparing the voltage signal with a first reference signal and converting the voltage signal into a digital signal of three or more values and second A/D conversion processing of comparing the voltage signal with a second reference signal and converting the voltage signal into a digital signal of three or more values; and
a signal processing unit, wherein
the first reference signal is a signal that changes over time in a first voltage region including a mode of the voltage signal output from a pixel that has not received the radiation,
the second reference signal is a signal that changes over time in a second voltage region that includes the voltage signal output from a pixel that has received the radiation and does not overlap the first voltage region, and
a third voltage region where A/D conversion processing is not executed is present between the first voltage region and the second voltage region.

2. The radiation detector according to claim 1, wherein a voltage width of the third voltage region is at least twice or more a voltage width corresponding to a quantization resolution in the first A/D conversion processing and the second A/D conversion processing.

3. The radiation detector according to claim 1, wherein
the A/D converter includes a reference signal generator configured to output the first reference signal and the second reference signal at different timings, and a comparator, and
the comparator is configured to compare the voltage signal with an output of the reference signal generator.

4. The radiation detector according to claim 1, wherein
the A/D converter includes a first comparator and a second comparator,
the first comparator is configured to compare the voltage signal with the first reference signal, and
the second comparator is configured to compare the voltage signal with the second reference signal.

5. The radiation detector according to claim 4, wherein a timing at which the first reference signal is input to the first comparator and a timing at which the second reference signal is input to the second comparator temporally overlap each other.

6. The radiation detector according to claim 1, wherein the first reference signal and the second reference signal are voltage signals having substantially equal slopes of voltage change with respect to time.

7. The radiation detector according to claim 1, wherein the first reference signal and the second reference signal are voltage signals having different slopes of voltage change with respect to time.

8. The radiation detector according to claim 1, wherein the A/D converter is configured to execute third A/D conversion processing of comparing a third reference signal that changes over time across the first voltage region, the third voltage region, and the second voltage region with the voltage signal and converting the voltage signal into a digital signal of three or more values.

9. The radiation detector according to claim 1, wherein the signal processing unit is configured to
acquire a background level included in the voltage signal based on a result of the first A/D conversion processing for voltage signals output from the plurality of the pixels in one frame, and
binarize an output of each of the plurality of pixels by using the background level and a result of the second A/D conversion processing for the voltage signals output from the plurality of pixels in the one frame.

10. The radiation detector according to claim 9, wherein the signal processing unit is configured to acquire, as the background level, any one of a mode, a median value, and an average value of the digital signal that is the result of the first A/D conversion processing.

11. The radiation detector according to claim 9, wherein the signal processing unit is configured to binarize an output of each of the plurality of pixels by subtracting the background level from the digital signal that is the result of the second A/D conversion processing and performing comparison with a predetermined threshold.

12. The radiation detector according to claim 9, wherein the signal processing unit is configured to acquire a threshold for binarizing an output of each of the plurality of pixels based on the background level.

13. The radiation detector according to claim 9, wherein the signal processing unit is configured to acquire the background level for the one frame by using the result of the first A/D conversion processing for the voltage signals output from all of the plurality of pixels in the one frame.

14. The radiation detector according to claim 9, wherein the signal processing unit is configured to acquire the background level for the pixels of one row by using the result of the first A/D conversion processing for the voltage signals output from the pixels of the one row in the one frame.

15. The radiation detector according to claim 9, wherein the signal processing unit is configured to acquire the background level for a specific pixel of the one frame by using the result of the first A/D conversion processing for the voltage signals output from pixels around the specific pixel.

16. A radiation imaging system comprising:
the radiation detector according to claim 1; and
a radiation source configured to apply radiation to an imaging target.

17. The radiation imaging system according to claim 16, wherein the radiation source is configured to control a radiation application rate such that an average value of the number of photons or particles of the radiation injected per frame and per pixel is 0.5 or less.

18. A radiation detection method comprising:
a reading step of reading, by a read circuit, voltage signals from a plurality of pixels, each pixel being configured to detect radiation and output voltage signal;
a first A/D conversion step of comparing by an A/D converter, the voltage signal with a first reference signal and converting the voltage signal into a digital signal of three or more values; and
a second A/D conversion step of comparing by the A/D converter, the voltage signal with a second reference signal and converting the voltage signal into a digital signal of three or more values, wherein
the first reference signal is a signal that changes over time in a first voltage region including a mode of the voltage signal output from a pixel that has not received the radiation,
the second reference signal is a signal that changes over time in a second voltage region that includes the voltage signal output from a pixel that has received the radiation and does not overlap the first voltage region, and
a third voltage region where the A/D converter does not execute A/D conversion processing is present between the first voltage region and the second voltage region.

19. The radiation detection method according to claim 18, further comprising:
a background level acquisition step of acquiring by a signal processing unit, a background level included in the voltage signal based on a result of the first A/D conversion step for the voltage signal in one frame read by the read circuit; and
a binarization step of binarizing, by the signal processing unit, an output of each of the plurality of pixels by using the acquired background level and a result of the second A/D conversion step in the one frame.

20. A storage medium storing a program for causing a computer to execute each step of the radiation detection method according to claim 19.
